(19) United States
(12) Patent Application Publication
(10) Pub. No.: US 2007/0034397 A1
(43) Pub. Date: Feb. 15, 2007

(54) Hand-held power tool with vibration-reducing means

(75) Inventors: Axel Fischer, Wiedergeltingen (DE); Ernst-Rudolf Luebkert, Landsberg (DE); Pierre Pallmer, Nebelschuetz (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/502,111

(22) Filed: Aug. 10, 2006

(30) Foreign Application Priority Data
Aug. 11, 2005 (DE) 10 2005 038 091.3

(51) Int. Cl. B25D 17/00

(52) U.S. Cl. 173/162.2

(57) ABSTRACT

A hand-held power tool (2) includes a main housing (4) in which a tool spindle (10) extending in the horizontal direction (Z) is at least partially received in the main housing (4), a handle housing (16), and intermediate lateral vibration-reducing element (40a; 56a) for supporting the handle housing (16) on the main housing (4) in a lateral direction (X), horizontal vibration-reducing element (40c, 56c) for supporting the handle housing (16) on the main housing (4) in the horizontal direction (Z), and a vertical vibration-reducing element (40b, 56c) for supporting the handle housing (16) on the main housing (4) in a vertical direction (Y).

### BACKGROUND OF THE INVENTION

1. Field of the Invention

The present invention relates to a hand-held power tool in which during an operation, vibrations are generated, and in particular, to an electrical hammer drill, chisel or percussion drill, a motorized saw, in particular, a fret or saber saw, a cutting or grinding tool, in particular an angle grinding tool.

2. Description of the Prior Art

A hand-held power tool of the type described above includes a main housing located in plane defined by a horizontal direction and a vertical direction extending perpendicular to the horizontal direction with the plane extending perpendicular to a lateral direction of the hand-held power tool, a tool spindle extending in the horizontal direction and at least partially received in the main housing, a handle housing and an intermediate lateral vibration-reducing element for supporting the handle housing on the main housing in the lateral direction.

Hand-held power tools of the above-described type are held with one hand, holding the handle. During the operation of a hand-held power tool, the vibrations, which appear on the main housing, are transmitted to the handle with a noticeably reduced intensity as a result of provision of vibration-reducing means. This insures a comfortable operation of the hand-held power tool for an extended period of time.

German Publication DE-3121882 discloses a hand-held power tool in which two U-shaped support elements are provided on each of the tool housing and the tool main handle. The support elements of the housing are connected, in a direction transverse to the longitudinal axis of the power tool, with the support elements of the main handle by two rubber pads, respectively. Thereby, the support elements can be displaced relative to each other, when a force acts in a direction of the tool longitudinal axis. In addition, the support elements are so formed that they abut each other upon an excessive rotation of the handle relative to the housing.

The drawback of this attachment of the handle to the hand-held power tool consists in that the rubber elements have, in their connection direction of the two support elements, relatively large dimensions or must be made relatively heavy in order to obtain a satisfactory vibration damping in the longitudinal direction. The large dimensions and/or weight can, however, lead to poor holding of the handle on the housing and, thereby, to a poor guidance of the power tool during an operation and even when an adequate vibration damping in the longitudinal direction, together with a good guidance stability, are achieved, the rubber pads do not permit to achieve simultaneously a comparatively good vibration damping, together with the same good guidance stability, in two directions extending perpendicular to the longitudinal direction. However, it is necessary to keep the total vibration on the handle which is transmitted to the user, low, together with good holding of the handle on the housing.

Moreover, the contemplated gluing of the rubber elements to the support elements and the mounting of the vibration damping elements on the hand-held power tool are relatively expensive.

Accordingly, an object of the present invention is to provide a hand-held power tool in which the above-mentioned drawbacks are eliminated and a stable guidance of the power tool, together with a satisfactory reduction of vibrations in all directions, are achieved.

### SUMMARY OF THE INVENTION

This and other objects of the present invention, which will become apparent hereinafter, are achieved by providing a hand-held power tool in which, in addition to the support of the handle housing on the main housing in the lateral direction with an intermediate lateral vibration-reducing element, there are further provided, an intermediate horizontal vibration-reducing element for supporting the handle housing on the main housing in the horizontal direction and an intermediate vertical vibration-reducing element for supporting the handle housing on the main housing in the vertical direction.

With the three intermediate vibration-reducing elements, the handle housing is held on the main housing by the intermediate vibration-reducing elements in all three directions. Thereby, a separate reduction of vibrations in each of the three directions can be adjusted. Thereby, a sufficiently stable support of the handle housing on the main housing is maintained, without hard engagement therebetween. This also permits to minimize total vibration acting on the handle housing during operation, insuring, at the same time, a stable guidance of the power tool.

According to an advantageous embodiment of the invention, the handle housing is supported on the main housing in each of the lateral, horizontal and vertical directions by a respective pair of vibration-reducing elements spaced form each other in a respective direction. The vibration-reducing elements of the respective pair are supported between the handle housing and the main housing in opposite directions.

According to a particularly advantageous embodiment of the present invention, in two of the horizontal, vertical and lateral directions, the respective vibration-reducing elements of respective pairs are preloaded against each other.

Thereby, in two of the holding directions of the handle housing on the main housing, a particularly high vibration damping, simultaneously with a particularly stable support of the handle housing on the main housing are achieved.

It is particularly advantageous when the respective vibration-reducing elements of the respective pairs are preloaded against each other in all of the horizontal, vertical and lateral directions.

In this case, an optimal damping of vibrations acting on the handle housing is achieved. Simultaneously, a stable support of the handle housing on the main housing and, thereby, an exact guidance of the hand-held power tool in all of the three directions becomes possible.

Advantageously, there is provided at least one elastic element forming the lateral vibration-reducing element, the horizontal vibration-reducing element and the vertical vibration-reducing element. With such an elastic element, the number of parts necessary for damping of the vibrations is reduced, which further simplifies the mounting of the handle housing on the main housing.

Advantageously, the at least one elastic element is circumferentially supported in a vertical housing opening of one of the handle housing and the main housing and has an opening extending parallel to the housing opening through which an element of another of the handle housing and the main housing extends.

The element of the other of the handle housing and the main housing can be formed, e.g., by a pin-shaped or similar element that forms an engagement profile projecting or extending from the respective housing. Such an element provides for a particular stable support of the handle housing on the main housing.

It is further particularly advantageous when the elastic element is supported, in the vertical direction, on both the handle and main housings in opposite directions. In this case, on the elastic element, in each of the three directions, there are provided two vibration-reducing elements which are supported in opposite directions on both handle and main housings. Thereby, with a single elastic element, a preload in all of the three directions is produced.

Advantageously, the vibration-reducing elements are formed, at least partially, of a foamed plastic material. Thereby, even complex shapes of the vibration-reducing elements or of the damping bodies can be cost-effectively produced.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 an exploded side view of a hand-held power tool according to the present invention;

FIG. 2 a partially cross-sectional side view of the hand-held power tool shown in FIG. 1;

FIG. 3 a cross-sectional view of a connection device of the power tool shown in FIG. 2 along line III-III;

FIG. 4 a perspective view of a first elastic element of the connection device of the inventive power tool;

FIG. 5 a perspective view of a second elastic element of the connection device of the inventive power tool;

FIG. 6 a view of a handle housing of the inventive power tool in direction VI in FIG. 1; and

FIG. 7 a plan view of the main housing of the inventive power tool in direction VII in FIG. 1.

### DETAILED DESCRIPTION OF THE PREFERRED EMBODIMENTS

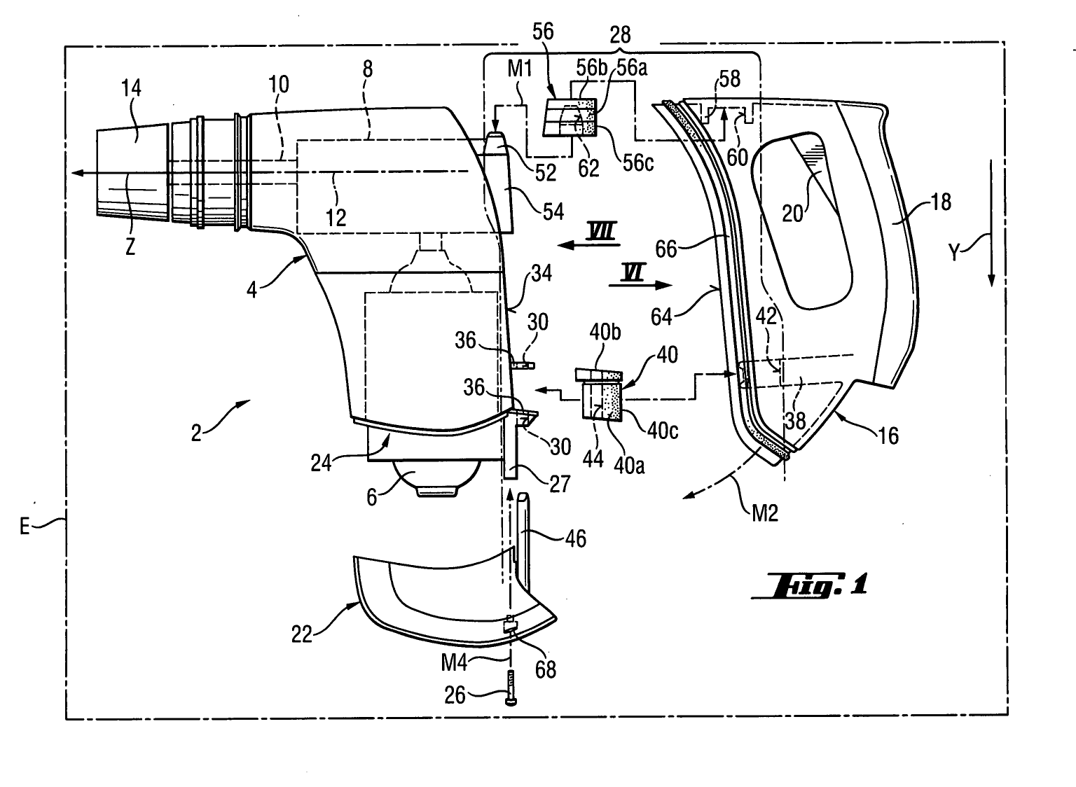

A hand-held power tool 2 according to the present invention, which is shown in FIG. 1, is formed as a hammer drill and has a substantially three-part housing. In a main housing 4, a motor 6 and a drive gear 8, which is shown only schematically, are arranged. The drive gear 8 drives a tool spindle 10, applying a rotary-percussion movement thereto. The tool spindle 10 extends in a horizontal direction Z. A chuck 14 is secured on the tool spindle 10 for joint rotation therewith.

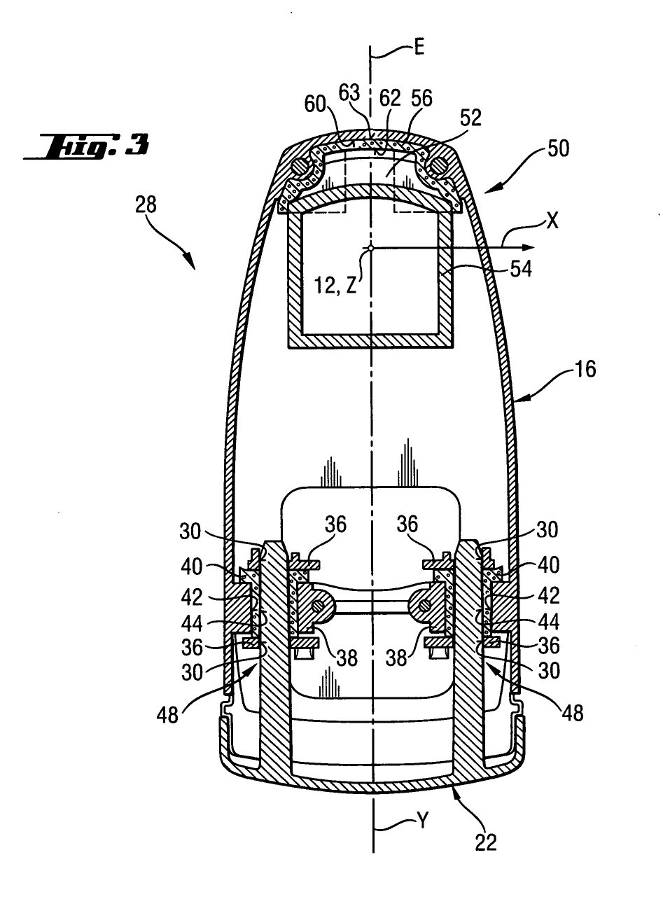

On a handle housing 16, a handle 18 is formed with which the hand-held power tool can be held with one hand. With the hand that holds the power tool 2, a push button 20, which is provided on the handle 18 can be actuated. The handle 18 extends substantially parallel to a vertical direction Y that extends perpendicular to the horizontal direction Z. The vertical direction Y and the horizontal direction Z lie in a common plane E that extends perpendicular to a lateral direction X, as shown in FIG. 3.

It should be pointed out that the indications lateral direction X, vertical direction Y, and a horizontal direction Z are simply exemplary for the shown hand-held power tool 2. Dependent on the type of the hand-held power tool 2, the foregoing directions can be directed differently. Further, the foregoing indications can deviate from the corresponding spatial directions dependent on the orientation of the hand-held power tool 2 in space.

Further, there is provided a motor cover 22 that is formed separately from the main housing 4. The motor cover 22 is secured to the main housing 4 over an opening 24 in the region of the motor 6. The motor cover 22 is secured to the main housing 4 with screws 26 and projections 27.

A connection device 28 connects the handle housing 16 with the main housing 4 and/or the motor cover 22.

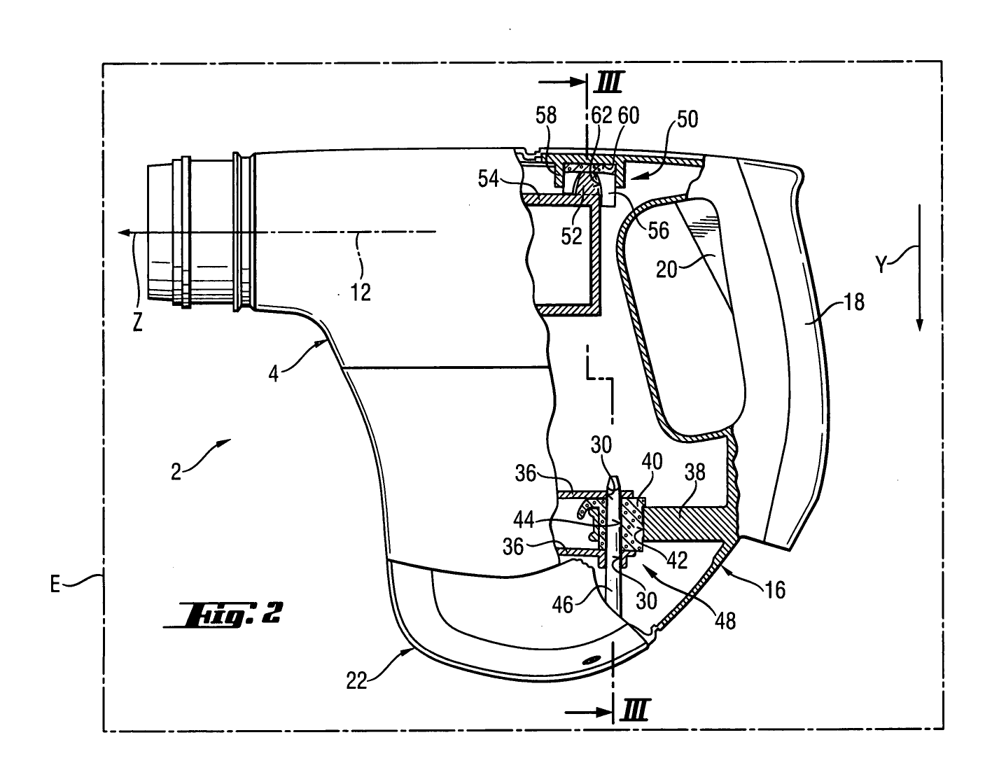

The connection device 28 includes first connection means 50 which includes a main housing side, convex engagement member 52 that projects from the drive gear housing 54 and that can be engaged from behind by a handle-side engagement member 58, with a first elastic element 56 being arranged there-between. The first elastic element 56 is formed of a foamed plastic material. The handle-side engagement member 58 has a substantially concave receptacle 60, which is formed in the handle housing 16 and in which the first elastic element 56 is inserted. The first elastic element 56 has a receiving space 62 which is open at one side and in which the convex engagement member 52 can be received, as it is particularly shown in FIG. 2.

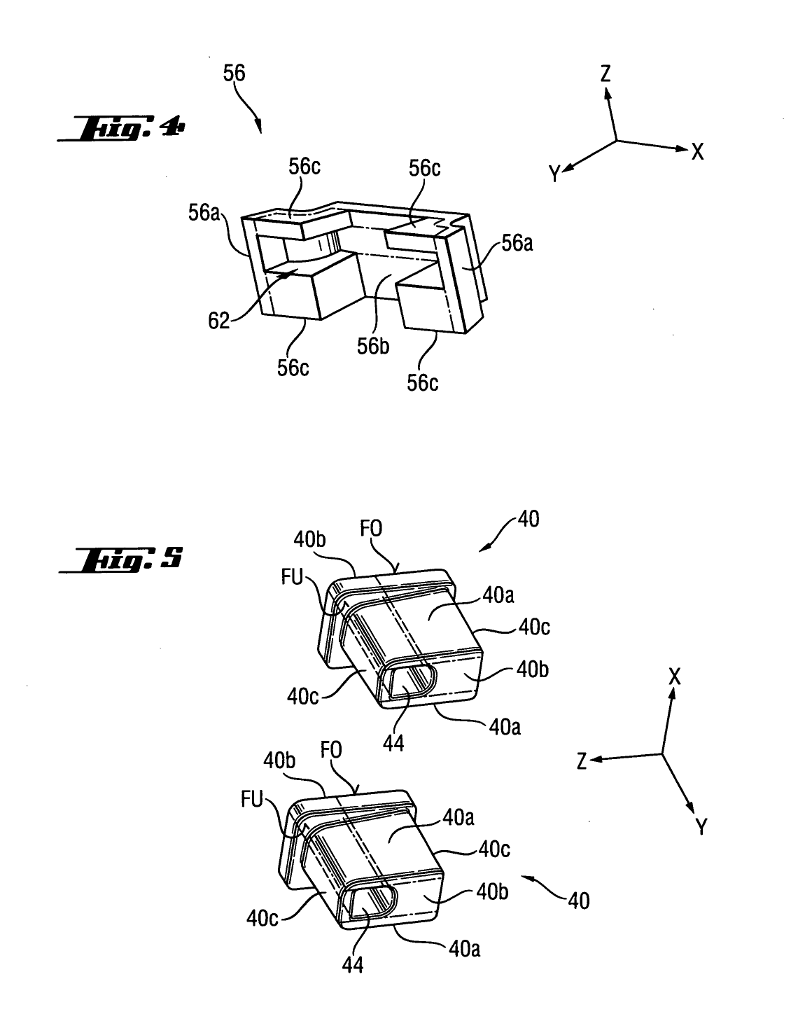

The first elastic element 56 is shown separately in FIG. 4 in perspective view. As it is shown with dash-dot lines in FIG. 4, the receiving space 62 is limited in the lateral direction X by two regions of the first elastic element 56 and which function as lateral vibration-reducing elements 56a. In the vertical direction Y, there is provided, on the first elastic element 56, a region that functions as a vertical vibration-reducing element 56b. In the horizontal direction, there are formed, on the first elastic element 56, four regions which function as horizontal vibration-reducing elements 56c.

The receiving space 62 has, in the lateral direction X, between both lateral vibration-reducing elements 56a, and in the horizontal direction Z, between respective two horizontal vibration-reducing elements 56c, a somewhat smaller extent than a respective extent of the convex engagement member 52 in a respective direction.

The connection device 28 further includes, on the main housing side, a plurality of openings 30 of a locking device likewise provided on the main housing side. The openings 30 are formed in four housing webs 36 which project from a rear side 34 of the main housing 4. As particularly shown in FIGS. 2-3, between each two respective housing webs 36, there is positioned an eyelet element 38 provided on the handle housing 16. The eyelet elements 38 are designed for receiving a second elastic element 40 likewise formed of a foamed plastics, and have, to this end, a through-opening 42 of the locking device provided on the handle side. The second elastic element 40 has a through-opening 44 that can be aligned with a respective adjacent, housing side opening 30.

The connection device 28 further includes two pin-shaped projections 46 which project from the motor cover 22. The openings 30, 42, the second elastic elements 40, and the projections 46 form, as it can be particularly seen in FIGS. 2-3, second connection means 48 of the connection device 28. The second connection means 48 are spaced from the first connection means 50 in the direction perpendicular to the operational axis 12.

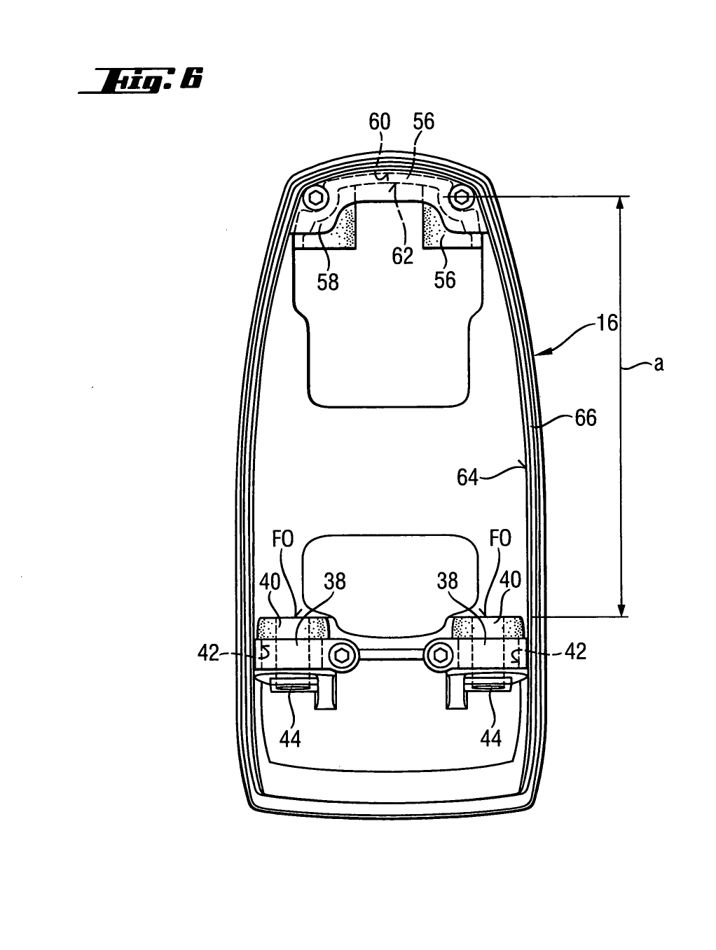

FIG. 5 shows a perspective view of both second elastic elements 40. As shown in FIG. 5 with dash-dot lines, a respective through-opening 44 is limited in the lateral direction X by two respective regions of the second elastic element 40 which function as lateral vibration-reducing elements 40a. In the horizontal direction Z, there are formed, on each of the two second elastic elements 40, two regions which function as horizontal vibration-reducing elements 40c.

On both second elastic elements 40, there is further formed a collar-shaped vertical vibration-reducing element 40b that projects, in the direction perpendicular to the vertical direction Y, over the remaining part of the respective second elastic element 40. Thereby, the vertical vibration-reducing elements 40b form, on their opposite sides, respective upper bearing surface FO and lower bearing surface FU extending transverse to the vertical direction Y.

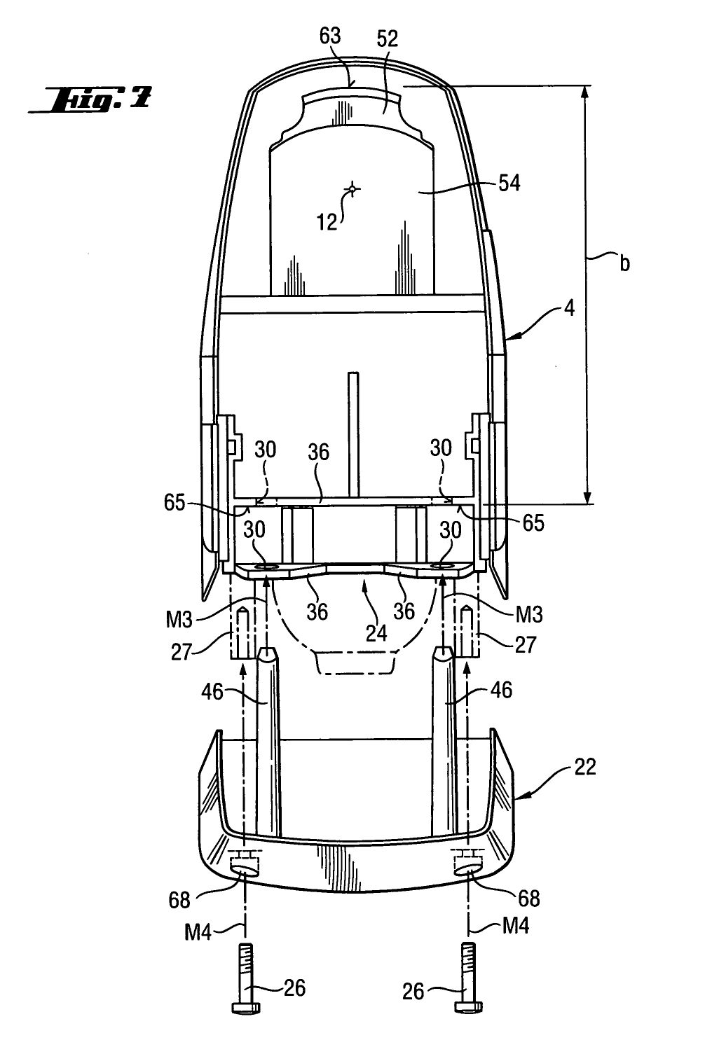

Upon assembly of the hand-held power tool 2, the first elastic element 56 is inserted in the receptacle 60 of the handle housing side, engagement member 58, as shown in FIG. 6. Further, the second elastic element 40 is inserted into the handle-side locking receptacle 42 screwed to the handle housing 1b.

Finally, the handle housing 16 is mounted on the main housing 4, with the engagement member 58, with the first elastic element 56 being received therein, being mounted on the convex engagement member 52, as shown in FIG. 1 by a mounting direction M1.

Because of smaller dimensions of the opening 62 in comparison with those of the convex engagement member 52, as it has been described above, the lateral vibration-reducing elements 56a and the horizontal vibration-reducing elements 56c are preloaded against each other in the receptacle 60. The convex engagement member 523 becomes clamped in the handle housing 16 with the lateral vibration-reducing elements 56a and the horizontal pressure-reducing elements 56c.

Finally, the handle housing 16 is pivoted, at its end remote from the operational axis 12, about the first connection means 50 on the main housing 4 in a mounting direction M2. The distance a between the vertical vibration-reducing element 56b of the first elastic element 56 in its unloaded condition and the both upper bearing surfaces FO of the second elastic elements 40 in their unloaded condition, according to FIG. 6, is somewhat smaller than the distance b, according to FIG. 7, between the upper edge 63 of the convex engagement member 52 and the bottoms 65 of respective housing webs 36 located in vicinity of the convex engagement member 52 and with which both upper bearing surfaces FO engage upon assembly.

Thus, the first elastic element 56 should be biased with some preload in the vertical direction Y in order to be able to pivot the eyelet elements 38, together with the second elastic elements 40 held therein, between the respective two housing webs 36.

In this way, the vertical vibration-reducing element 56b of the first elastic element 56 and the vertical vibration-reducing element 40b of the second elastic elements 40 are preloaded against each other. Thereby, the convex engagement member 52 and the two, arranged nearby, housing webs 36 with the arranged vertically therebetween, vertical vibration-reducing element 56b and vertical vibration-reducing elements 40b are damped between the receptacle 60 and the eyelet elements 36 of the handle housing 16, as shown in FIG. 3.

Simultaneously the through-opening 44 of the second elastic element 40, which is held in the handle-side locking receptacle 42, is aligned with the main housing side locking receptacle 30.

As shown in FIG. 1, an elastic seal 66 is provided on an edge 64 of the handle housing 16 along which the handle housing 16 adjoins the main housing 4 and the motor cover 22, for sealing the tool housing interior from outside.

In a third mounting step, the motor cover 22 is secured on the main housing 4 over the housing opening 24 in the mounting direction M3, as shown in FIG. 7. During mounting of the motor cover 22 on the main housing 4, the projections 46 are pushed through the handle-side locking receptacles 42 and the second elastic elements 40. Thereby, the handle-side locking receptacles 42 become formlockingly connected with the main housing side, locking receptacles 30 by the projections 46, with the respective second elastic elements 40 arranged between the projections 46 and the receptacles.

The two through-openings 44 have a somewhat smaller extent in the lateral direction X between both lateral vibration-reducing elements 40a and in the horizontal direction Z between the horizontal vibration-reducing elements 40c, then the respective extent of the projections 46 in the respective directions. Because of the smaller dimensions of the through-openings 44 in comparison with those of the projections 46, the lateral vibration reducing elements 40a and the horizontal vibration-reducing elements 40c are preloaded pairwise against each other in the handle-side locking receptacles 42. In this way, the projections 46 are damped with lateral vibration-reducing elements 40a and/or the horizontal vibration-reducing elements 40c in the handle housing 16.

Altogether, the handle housing 16 is held in all of the three directions X, Y, Z by respective pairs of preloaded against each other, vibration-reducing elements 40a, 40b, 40c and 56a, 56b, 56c on the main housing 16, i.e., the handle housing 16 is held on the main housing 4, without hardly engaging the housing 4. The first and second elastic elements 56 and 40 and, thus, the vibration-reducing elements 40a, 40b, 40c and 56a, 56b, 56c are made of a foamed plastic material and, therefore, can damp the transfer of vibrations from the main housing 4 to the handle housing 16 during operation in all of the three directions X, Y, Z. This substantially reduces the vibrations of the handle 18, insuring a stable guidance of the hand-held power tool 2.

With the screws 26, which are extended through the screw openings 68 in the motor cover 22 in the mounting direction M4 and screwed into the extensions 27, the position of the motor cover 22 on the main housing 4 and, thereby, the formlocking connection of the handle housing 16 with the main housing 4 at the second connection means 48 are insured.

Simultaneously, with the formation of a formlocking connection of the handle housing 16 with main housing 4 by the second connection means 48, the engagement member 58 is so closely held on the engagement member 52 in the direction perpendicular to the operational axis 12, that it cannot pivot thereabout. Thus, with the formation of the formlocking connection between the handle housing 16 and the main housing 4 by the second connection means 48, engagement of the handle housing 16 with the main housing 4 by the first connection means 50 becomes locked.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held power tool (2), comprising a main housing (4) located in plane (E) defined by a horizontal direction (Z) and a vertical direction (Y) extending perpendicular to the horizontal direction, the plane (E) extending perpendicular to a lateral direction (X) of the hand-held power tool (2); a tool spindle (10) extending in the horizontal direction (Z) and at least partially received in the main housing (4); a handle housing (16); intermediate lateral vibration-reducing element (40a; 56a) for supporting the handle housing (16) on the main housing (4) in the lateral direction (X), horizontal vibration-reducing element (40c, 56c) for supporting the handle housing (16) on the main housing (4) in the horizontal direction (Z), and a vertical vibration-reducing element (40b, 56c) for supporting the handle housing (16) on the main housing (4) in the vertical direction (Y).

2. A hand-held power tool according to claim 1, wherein the handle housing (16) is supported on the main housing (4) in each of the lateral, horizontal and vertical directions (X, Z, Y) by a respective pair of vibration-reducing elements (40a, 56a; 40c, 56c; and 40b, 56b) spaced from each other in a respective direction, with vibration-reducing elements of the respective pair being supported between the handle housing (16) and the main housing (4) in opposite directions.

3. A hand-held power tool according to claim 2, wherein in two of the horizontal (Z), vertical (Y), and lateral (X) directions, the respective vibration-reducing elements (40a, 40b, 40c, 56a, 56b, 56c) of respective pairs are preloaded against each other.

4. A hand-held power tool according to claim 3, wherein the respective vibration-reducing elements (40a, 40b, 40c, 56a, 56b, 56c) of the respective pairs are preloaded against each other in all of the horizontal (Z), vertical (Y), and lateral (X) directions.

5. A hand-held power tool according to claim 1, comprising at least one elastic element (40, 56) forming the lateral vibration-reducing element (40a; 56a), the horizontal vibration-reducing element (40c; 56c), and the vertical vibration-reducing element (40b; 56b).

6. A hand-held power tool according to claim 5, wherein the at least one elastic element (40; 56) is circumferentially supported in a vertical housing opening of one of the handle housing (16) and the main housing (4) and has an opening extending parallel to the housing opening through which an element (46, 52) of another of the handle housing (16) and the main housing (4) extends.

7. A hand-held power tool according to claim 6, wherein the at least one elastic element (40, 56) is supported on both housings (4, 16) in opposite directions in the vertical direction (Y).

8. A hand-held power tool according to claim 1, wherein the vibration-reducing elements (40a, 40b, 40c, 56a, 56b, 56c) are formed, at least partially, of a foamed plastic material.
